(19) United States
(12) Patent Application Publication
(10) Pub. No.: US 2012/0237251 A1
(43) Pub. Date: Sep. 20, 2012

(54) IMAGE FORMING APPARATUS

(75) Inventors: Hiroki Matsuura, Kanagawa (JP); Takeshi Fukao, Kanagawa (JP)

(73) Assignee: RICOH COMPANY, LTD., Tokyo (JP)

(21) Appl. No.: 13/412,174

(22) Filed: Mar. 5, 2012

(30) Foreign Application Priority Data
Mar. 17, 2011 (JP) 2011-059599

(51) Int. Cl. G03G 15/16

(52) U.S. Cl. 399/101

(57) ABSTRACT

An image forming apparatus includes an image bearing member to bear a toner image on a surface thereof, an intermediate transfer member disposed facing the image bearing member, onto which the toner image is transferred, a primary transfer device disposed opposite the image bearing member with the intermediate transfer member interposed therebetween to transfer the toner image from the image bearing member onto the intermediate transfer member, a cleaning device detachably attachable relative to the intermediate transfer member and including a cleaning member to contact the surface of the intermediate transfer member to remove residual toner remaining on the intermediate transfer member after transfer of the toner image, and a lubricant application device detachably attachable relative to the intermediate transfer device to apply a lubricant on the surface of the intermediate transfer member. The cleaning device and the lubricant application device are detachably attachable independent of each other.

### CROSS-REFERENCE TO RELATED APPLICATION

This patent application is based on and claims priority pursuant to 35 U.S.C. §119 to Japanese Patent Application No. 2011-059599, filed on Mar. 17, 2012 in the Japanese Patent Office, the entire disclosure of which is hereby incorporated by reference herein.

### BACKGROUND OF THE INVENTION

1. Field of the Invention

Exemplary aspects of the present invention generally relate to an image forming apparatus, and more particularly, to an image forming apparatus using an intermediate transfer method using an intermediate transfer member and a lubricant application device to apply lubricant to the intermediate transfer member.

2. Description of the Related Art

Related-art image forming apparatuses, such as copiers, facsimile machines, printers, or multifunction printers having at least one of copying, printing, scanning, and facsimile capabilities, typically form an image on a recording medium according to image data. Thus, for example, a charger uniformly charges a surface of an image bearing member (which may, for example, be a photoconductive drum); an optical writer projects a light beam onto the charged surface of the image bearing member to form an electrostatic latent image on the image bearing member according to the image data; a developing device supplies toner to the electrostatic latent image formed on the image bearing member to render the electrostatic latent image visible as a toner image; the toner image is directly transferred from the image bearing member onto a recording medium or is indirectly transferred from the image bearing member onto a recording medium via an intermediate transfer member; a cleaning device then cleans the surface of the image carrier after the toner image is transferred from the image carrier onto the recording medium; finally, a fixing device applies heat and pressure to the recording medium bearing the unfixed toner image to fix the unfixed toner image on the recording medium, thus forming the image on the recording medium.

In an image forming apparatus for producing a color image, such as a tandem-type image forming apparatus, a plurality of imaging stations, one for each of the colors, for example, yellow, cyan, magenta, and black, is arranged facing an intermediate transfer member such as a transfer belt onto which toner images formed in the imaging stations are primarily transferred one atop the other to form a composite color image. This process is known as a “primary transfer process”. After the primary transfer process, the composite color toner image is secondarily transferred onto a recording medium, such as a sheet of paper, in a process known as a “secondary transfer process”.

After the secondary transfer in which the composite toner image is transferred from the intermediate transfer member to the recording medium, the surface of the intermediate transfer member is cleaned by a cleaning device such as a cleaning blade. The cleaning blade contacts the surface of the intermediate transfer member to remove the residual toner remaining thereon.

In order to produce a high-resolution image, there is strong market demand for toner constituted of fine particles, each having a shape as much spherical as possible. However, such toner easily slips through the cleaning blade during cleaning and hence remains on the surface of the intermediate transfer member.

To counteract such difficulty, the pressure of the cleaning blade contacting the intermediate transfer member may be increased. Although advantageous, increasing the contact pressure of the cleaning blade accelerates degradation of the cleaning blade, hence shortening the useful life of the cleaning blade.

To prevent wear on the cleaning blade, a lubricating agent is applied on the surface of the intermediate transfer member so that the toner is difficult to stick thereto and also a friction coefficient between the cleaning blade and the surface of the intermediate transfer member is reduced, such as in JP2002-258668-A.

In this configuration, a solid lubricant is applied to the surface of the intermediate transfer member by a brush roller which scrapes the lubricant and applies it to the intermediate transfer member by contacting the intermediate transfer member.

In a known tandem-type image forming apparatus, such as in JP-H11-268658-A, a belt-type intermediate transfer member (hereinafter an intermediate transfer belt) is formed into an endless belt, entrained around a plurality of rollers, and stretched taut. A cleaning unit including a cleaning blade for cleaning the intermediate transfer belt, and a lubricant application unit including a brush roller for application of the lubricant are constituted as a single integrated unit and disposed across from one of the plurality of rollers disposed at one end of the stretched surface of the intermediate transfer belt.

After transferring the composite toner image from the intermediate transfer belt to the recording medium, the cleaning blade removes the residual toner remaining on the intermediate transfer belt, and then the brush roller applies the lubricant on the surface of the intermediate transfer belt while the intermediate transfer belt is pressed against the brush roller by an opposed roller via the intermediate transfer belt.

In this configuration, because the cleaning unit and the lubricant application unit are constituted as a single integrated unit, even when each part in the cleaning unit and the lubricant application unit has different product life cycles, the entire unit including the cleaning unit and the lubricant application unit needs to be taken out together from the image forming apparatus and replaced with a new unit.

As a result, even the parts that do not need to be replaced are forced to be removed from the image forming apparatus before reaching the end of their product life cycles, thereby degrading utilization efficiency and increasing running cost. Furthermore, the related-art cleaning unit and the lubricant application unit constituted as a single integrated unit is disposed protruding from the end portion of the looped intermediate transfer belt in the horizontal direction, that is, the direction of travel of the intermediate transfer belt. Consequently, the size of the recording medium in the horizontal direction is increased to accommodate the lubricant application unit and the cleaning unit.

In view of the above, there is demand for an image forming apparatus capable of replacing the cleaning device and the lubricant application device independent of each other.

### BRIEF SUMMARY

In view of the foregoing, in an aspect of this disclosure, an image forming apparatus includes an image bearing member, an intermediate transfer member, a primary transfer device, a secondary transfer device, a cleaning device, and a lubricant application device. The image bearing member bears a toner image on a surface thereof. The intermediate transfer member is disposed facing the image bearing member, onto which the toner image is transferred. The primary transfer device is disposed opposite the image bearing member with the intermediate transfer member interposed therebetween, to transfer the toner image from the image bearing member onto the intermediate transfer member. The secondary transfer device transfers the toner image on the intermediate transfer member onto a recording medium. The cleaning device is detachably attachable relative to the intermediate transfer member and includes a cleaning member to contact the surface of the intermediate transfer member to remove residual toner remaining on the intermediate transfer member after transfer. The lubricant application device is detachably attachable relative to the intermediate transfer device, to apply a lubricant on the surface of the intermediate transfer member. The cleaning device and the lubricant application device are detachably attachable independent of each other.

The aforementioned and other aspects, features and advantages would be more fully apparent from the following detailed description of illustrative embodiments, the accompanying drawings and the associated claims.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic diagram illustrating an image forming apparatus according to an illustrative embodiment of the present invention;

FIG. 2 is a schematic diagram illustrating an intermediate transfer member, a lubricant application device, and a cleaning device of the image forming apparatus according to an illustrative embodiment of the present invention;

FIG. 3A is a perspective view schematically illustrating the lubricant application device and the cleaning device at a proximal side according to an illustrative embodiment of the present invention; and

FIG. 3B is a perspective view schematically illustrating the lubricant application device and the cleaning device at a distal end side according to an illustrative embodiment of the present invention.

### DETAILED DESCRIPTION OF DISCLOSED EMBODIMENTS

A description is now given of illustrative embodiments of the present application. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

In a later-described comparative example, illustrative embodiment, and alternative example, for the sake of simplicity, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but includes other printable media as well.

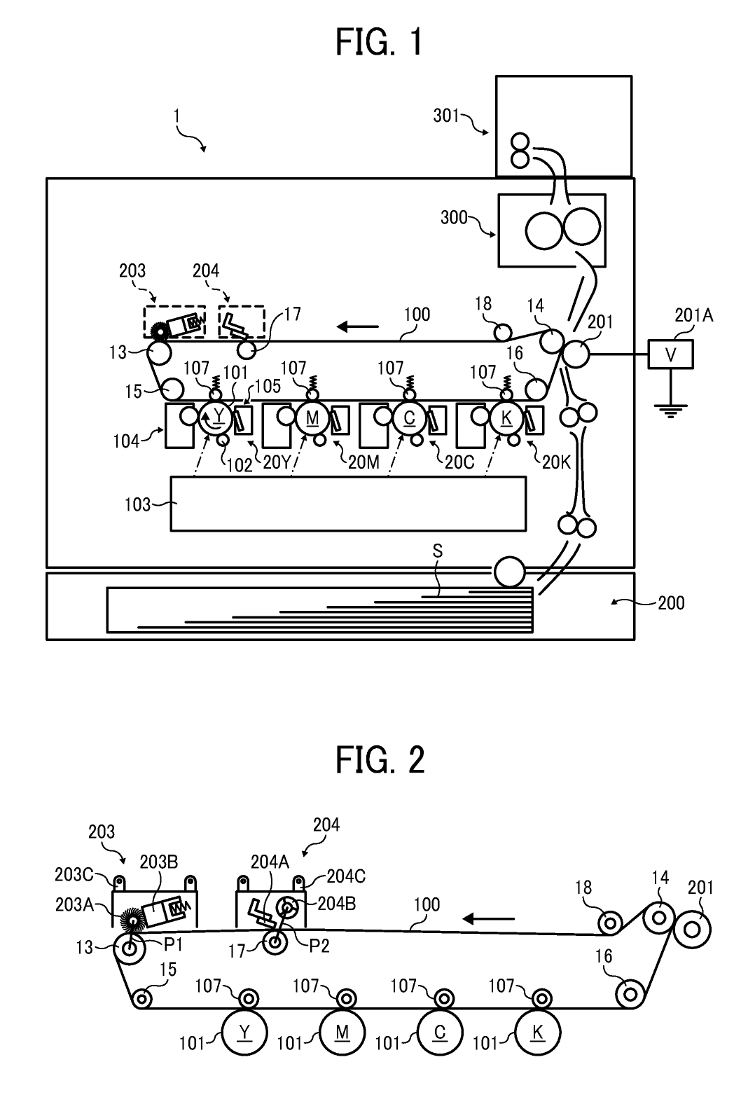

Referring now to the drawings, wherein like reference numerals designate identical or corresponding parts throughout the several views, and initially with reference to FIG. 1, a description is provided of an image forming apparatus according to an aspect of this disclosure.

FIG. 1 is a schematic diagram illustrating an image forming apparatus 1 according to an illustrative embodiment of the present invention. As will be described later, the image forming apparatus 1 illustrated in FIG. 1 is a tandem-type image forming apparatus using an intermediate transfer method in which a toner image is indirectly transferred from an image bearing member onto a recording medium via an intermediate transfer member.

The image forming apparatus 1 includes a sheet feed unit 200 at the bottom of the image forming apparatus 1, an optical writing unit 103 disposed above the sheet feed unit 200, a belt-type intermediate transfer member 100 (hereinafter referred to simply as intermediate transfer belt) serving as a primary transfer member disposed substantially at the center of the image forming apparatus 1, image forming stations 20Y, 20M, 20C, and 20K, one for each of the colors yellow, magenta, cyan, and black, arranged in tandem along the intermediate transfer belt 100, and so forth. The intermediate transfer belt 100 is formed into an endless loop entrained around a plurality of rollers 13, 14, 15, and 16, and stretched taut.

The image forming stations 20Y, 20M, 20C, and 20K, one for each of the colors yellow, magenta, cyan, and black, are arranged in tandem below and outside the loop formed by the intermediate transfer belt 100. It is to be noted that suffixes Y, M, C, and K indicate the colors yellow, magenta, cyan, and black, respectively. The image forming stations 20Y, 20M, 20C, and 20K all have the same configuration as all the others, differing only in the color of toner employed. To simplify the description, the suffixes Y, M, C, and K indicating colors are omitted herein, unless otherwise specified.

As illustrated in FIG. 1, each of the image forming stations 20 includes a photoconductive drum 101 facing the intermediate transfer belt 100. The photoconductive drum 101 is surrounded by various pieces of imaging equipment, such as a charging device 102, an optical writing unit 103, a developing device 104, a transfer roller 107, a drum cleaner 105, and a charge neutralizing device (not illustrated). The charging device 102 charges the surface of the photoconductive drum 101 at a certain electric potential. The optical writing unit 103 illuminates the charged surface of the photoconductive drum 101 with light, thereby forming an electrostatic latent image on the surface of the photoconductive drum 101.

The developing device 104 develops the electrostatic latent image on the surface of photoconductive drum 101 with the respective color of toner, thereby forming a visible image, also known as a toner image. The transfer roller 107 transfers the toner image onto the intermediate transfer belt 100 so that they are superimposed one atop the other, thereby forming a composite toner image. After transferring the toner image from the photoconductive drum 101 to the intermediate transfer belt 100, the drum cleaner 105 removes residual toner remaining on the surface of the photoconductive drum 101.

As described above, the toner images formed on the photoconductive drums 101 are transferred onto the intermediate transfer belt 100. Thus, a bias power source is disposed opposite the photoconductive drum 101 via the intermediate transfer belt 100 to supply a transfer bias to the transfer roller 107.

As illustrated in FIG. 1, the intermediate transfer belt 100 is wound around the plurality of rollers: the driving roller 13, the driven roller 14 serving as a tension roller, driven rollers 15 and 16 to stretch taut the intermediate transfer belt 100 at each end in the horizontal direction. The intermediate transfer belt 100 is rotated by these rollers in the direction of arrow in FIG. 1.

The composite toner image is transferred onto a recording medium fed from the sheet feed unit 200 by a secondary transfer roller 201 serving as a secondary transfer device supplied with a bias by a transfer bias power source 201A. This process is known as secondary transfer.

The recording medium on which the composite toner image is transferred is transported to a fixing device 300 disposed downstream from the secondary transfer roller 201 in the direction of transport of the recording medium. In the fixing device 30, heat and pressure are applied to the recording medium bearing the composite toner image, thereby fixing the image. After the image is fixed on the recording medium, the recording medium is sent to a sheet discharging device 301 and discharged outside the image forming apparatus 1.

In the imaging stations 20, after the toner images are transferred from the photoconductive drum 101 to the intermediate transfer belt 100 in the primary transfer process, the drum cleaner 105 removes residual toner remaining on the photoconductive drum 101 and then the intermediate transfer belt 100 is charged evenly by the charging device 102 in preparation for the subsequent imaging cycle.

As for the intermediate transfer belt 100, after the composite toner image is transferred onto the recording medium in the secondary transfer process, that is, after passing through the secondary transfer roller 201, the intermediate transfer belt 100 undergoes cleaning and application of a lubricant. The residual toner remaining on the intermediate transfer belt 100 is removed and the lubricant is applied thereon.

Before describing in detail about the key feature of the present invention, a description is provided of the intermediate transfer belt 100. According to the illustrative embodiment, the intermediate transfer belt 100 is comprised of a single layer or a multilayer structure including, but not limited to, polyimide (PI), polyvinylidene fluoride (PVDF), ethylene tetrafluoroethylene (ETFE), and polycarbonate (PC). Additionally, in order to adjust the resistance, a conductive material such as carbon black is dispersed in a layer of the intermediate transfer belt 100 so that the volume resistivity thereof is adjusted to within a range from 108 Ωcm to 1012 Ωcm, and a surface resistivity thereof is adjusted to within a range from to 109 Ωcm to 1013 Ωcm. It is to be noted that the surface of the intermediate transfer belt 100 may be coated with a release layer.

In this case, the release layer may include, but is not limited to, fluorocarbon resin such as ETFE, polytetrafluoroethylene (PTFE), PVDF, perfluoroalkoxy polymer resin (PFA), fluorinated ethylene propylene (FEP), and polyvinyl fluoride (PVF). The intermediate transfer belt 100 is manufactured through a casting process, a centrifugal casting process, and the like. The surface of the intermediate transfer belt 10 may be polished as necessary.

If the volume resistivity of the intermediate transfer belt 100 exceeds the above described range, the bias necessary for the transfer process increases, hence increasing the power and its cost.

Furthermore, an electrical potential of the intermediate transfer belt 100 increases during the transfer process and separation of the recording medium from the intermediate transfer belt 100, hindering self discharge. As a result, a charge eliminating device is required. By contrast, if the volume resistivity and the surface resistivity are below the above described range, attenuation of the electrical potential is fast, which is advantageous for elimination of charge. However, an electrical current flows in both directions during transfer, causing toner to scatter.

For the reasons described above, the volume resistivity and the surface resistivity of the intermediate transfer belt 100 need to be within the above described range. The volume resistivity and the surface resistivity can be measured by connecting an HRS Probe having an inner electrode diameter of 5.9 mm and an (inner) ring caliber of 11 mm (manufactured by Mitsubishi Chemical, Ltd.) to a high resistivity meter, Hiresta IP, (manufactured by Mitsubishi Chemical, Ltd.). The volume resistivity is calculated after 10 seconds elapse when a voltage of 100V (for the surface resistivity, a voltage of 500V) is applied to both sides of the intermediate transfer belt 100.

With reference to FIG. 1, a description is provided of a lubricant application device 203 for applying a lubricant to the intermediate transfer belt 100 and a belt cleaning device 204 for cleaning the surface of the intermediate transfer belt 100.

The image forming apparatus 1 includes the lubricant application device 203 and the cleaning device 204 disposed closely next to each other outside the loop formed by the intermediate transfer belt 100. The cleaning device 204 is disposed upstream from the lubricant application device 203 in the direction of movement of the intermediate transfer belt 100 so that the residual toner remaining on the intermediate transfer belt 100 is removed therefrom, and then the lubricant application device 203 disposed downstream from the cleaning device 204 applies the lubricant to the surface of the belt 100.

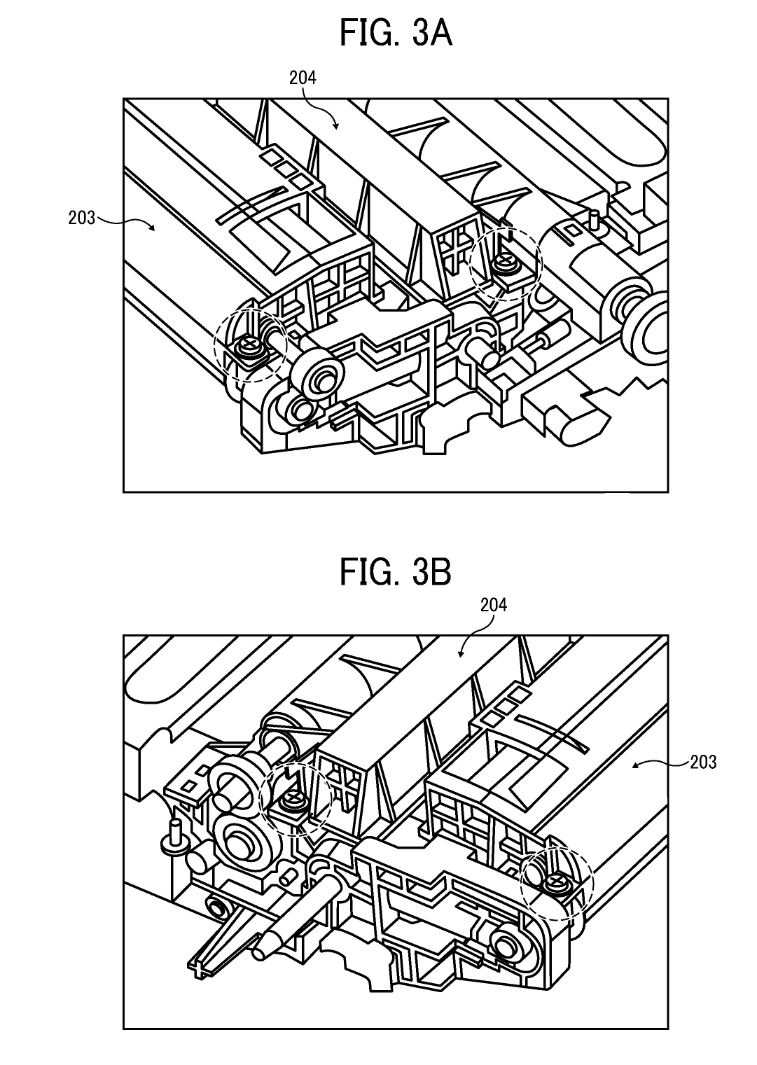

With reference to FIGS. 2 and 3, a detailed description is provided of the lubricant application device 203 and the cleaning device 204 according to an illustrative embodiment of the present invention. FIG. 2 is a schematic diagram illustrating relative positions of the intermediate transfer belt 100, the lubricant application device 203, and the cleaning device 204 in the image forming apparatus 1. FIG. 3A is a perspective view schematically illustrating the lubricant application device 203 and the cleaning device 204 at a proximal side. FIG. 3B is a perspective view schematically illustrating the lubricant application device 203 and the cleaning device 204 at a distal end side.

As illustrated in FIG. 2, the lubricant application device 203 and the cleaning device 204 are disposed independent of each other facing the intermediate transfer belt 100. The lubricant application device 203 is comprised of a lubricant enclosure 203C in which an application brush 203A and a lubricant 203B are disposed. The cleaning device 204 is comprised of a cleaner enclosure 204C in which a cleaning blade 204A and a toner transport member 204B are disposed.

More specifically, the lubricant enclosure 203C of the lubricant application device 203 and the cleaner enclosure 204C of the cleaning device 204 are detachably attachable independent of each other relative to the intermediate transfer belt 100. That is, as illustrated in FIGS. 3A and 3B, the lubricant enclosure 203C and the cleaner enclosure 204C are detachably attached to front and rear frames of the intermediate transfer belt 100 using screws as indicated by broken-line circles in FIGS. 3A and 3B. With this configuration, the lubricant application device 203 is detachably attachable independent of the cleaning device 204, relative to the intermediate transfer belt 100. Similarly, the cleaning device 204 is detachably attachable independent of the lubricant application device 203 relative to the intermediate transfer belt 100.

According to the present embodiment, since the lubricant application device 203 and the cleaning device 204 are independently and detachably fixed to the front and rear frames of the intermediate transfer belt 100 using screws, the lubricant application device 203 and the cleaning device 204 can be replaced separately at different timing as necessary with a simple configuration.

Referring back to FIG. 2, a detailed description is provided of the lubricant application device 203. As illustrated in FIG. 2, the application brush 203A and the lubricant 203B are disposed in the lubricant enclosure 203C of the lubricant application device 203. The application brush 203A is rotatable while contacting the intermediate transfer belt 100. The application brush 203A contacts the lubricant 203B while rotating, thereby scraping the lubricant 203B and applying the lubricant to the intermediate transfer belt 100. The lubricant 203B is pressed against the application brush 203A by an elastic member, such as a spring so that the lubricant 203B always contacts reliably the application brush 203A.

The lubricant 203B is comprised of a metal salt of a fatty acid having a linear hydrocarbon chain. The fatty acid may include at least one of, for example, myristic acid, palmitic acid, stearic acid, and oleic acid. The metal may include at least one of, for example, lithium, magnesium, calcium, strontium, zinc, cadmium, aluminum, cerium, or titanium. Examples of suitable metal salt of fatty acids include, but are not limited to, magnesium stearate, aluminum stearate, iron stearate, and zinc stearate.

Among these examples, zinc stearate is most preferable. Zinc stearate has been mass produced and has a long history of use in many different fields. Thus, for its cost and reliable quality, zinc stearate is most preferable.

The metal salt of fatty acid is not limited to a combination of a fatty acid and a metal salt. Alternatively, other suitable combination of fatty acids and metal salts may be used. Furthermore, the metal salts of fatty acids may contain metal oxide and free fatty acid.

The cleaning blade 204A and the toner transport member 204B are disposed in the cleaner enclosure 204C of the cleaning device 204. The cleaning blade 204A is made of rubber such as urethane rubber and removes residual toner remaining on the intermediate transfer belt 100. The toner transport member 204B is comprised of an auger screw made of resin or a helical member made of metal to transport the residual toner removed from the intermediate transfer belt 100 to a predetermined place.

With this configuration, the waste toner collected by the toner transport member 204B is prevented from accumulating in the cleaning device 204 before the cleaning blade 204A reaches its product life. Furthermore, because the toner transport device 204B is an auger screw or has a helical shape, the manufacturing cost for the toner transport device 204B is relatively low without degrading the transport efficiency.

The cleaning blade 204A is disposed such that the tip thereof faces against the direction of travel of the intermediate transfer belt 100 and contacts the intermediate transfer belt 100 with a predetermined angle. Accordingly, the cleaning blade 204A can reliably remove the residual toner remaining on the intermediate transfer belt 100.

The application brush 203A of the lubricant application device 203 and the cleaning blade 204A of the cleaning device 204 are disposed opposite the rollers 13 and 17, respectively, with the intermediate transfer belt 100 interposed therebetween. With this configuration, both the application brush 203A and the cleaning blade 204A can contact reliably the intermediate transfer belt 100.

More specifically, the application brush 203A contacts the driving roller 13 serving as a tension roller around which the intermediate transfer belt 100 is entrained. The cleaning blade 204A contacts the roller 17 which is disposed inside the loop formed by the intermediate transfer belt 100 between the rollers 13 and 14. The rollers 13 and 14 are disposed inside the loop formed by the intermediate transfer belt 100 at each end of the stretched loop. In other words, the roller 13 opposite the application brush 203A is a roller other than the roller opposite the cleaning blade 204A.

It is to be noted that a roller 18 disposed outside the loop formed by the intermediate transfer belt 100 serves as a tension roller that stretches the surface of the intermediate transfer belt 100 from outside the looped belt.

As described above, the lubricant application device 203 and the cleaning device 204 are disposed between the stretched ends of the intermediate transfer belt 100 so that the lubricant application device 203 and the cleaning device 204 do not protrude beyond the looped belt 100 in the horizontal direction. Accordingly, the occupied space by the lubricant application device 203 and the cleaning device 204 in the horizontal direction, that is, the stretch direction of the intermediate transfer belt 100, is within the length of the belt loop formed by the intermediate transfer belt 100 in the direction of travel thereof, thereby making the image forming apparatus as a whole as compact as is usually desired.

As illustrated in FIG. 2, the application brush 203A of the lubricant applicator 203 and the toner transport member 204B of the cleaning device 204 are driven by existing devices so that a dedicated driving device is not necessary.

More specifically, the application brush 203A is linked to the opposed roller, that is, the driving roller 13. As the driving roller 13 rotates, rotation thereof is transmitted to the application brush 203A via a rotation transmission path P1. The toner transport member 204B is linked to the roller 17 opposite the cleaning blade 204A. As the roller 17 rotates, rotation thereof is transmitted to the toner transport member 204B via a rotation transmission path P2.

As described above, the application brush 203A is driven by the different roller disposed at a different position, different from the roller that drives the toner transport member 204B. With this configuration, a drive transmission path can be relatively short, and no dedicated driving device is needed. Accordingly, removal of residual toner and application of lubricant can be performed without a dedicated driving device and hence at low cost. Furthermore, since the application brush 203A and the toner transport member 204B are driven by different rollers, the lubricant application device 203 and the belt cleaning device 204 can be replaced independent of each other.

According to the illustrative embodiment, the frequency of replacement of the lubricant application device 203 and the cleaning device 204 is, for example, a unit fraction (a fraction with numerator 1) of the frequency of replacement of the intermediate transfer belt 100.

With this configuration, even when the intermediate transfer belt 100 needs to be replaced, each part in the lubricant applicator 203 and the cleaning device 204 can still be used until the end of product life cycles, thereby reducing need to call a maintenance personnel to replace parts.

According to the illustrative embodiment, the lubricant application device 203 and the cleaning device 204 are detachably attachable independent of each other relative to the intermediate transfer belt 100. Therefore, each part in the lubricant applicator 203 and the cleaning device 204 can be replaced only when reaching the product life cycles. In other words, the parts are not replaced before reaching the end of their product life cycles, hence increasing efficiency of use and reducing unavailable time of the image forming apparatus.

According to an aspect of this disclosure, the present invention is employed in the image forming apparatus. The image forming apparatus includes, but is not limited to, an electrophotographic image forming apparatus, a copier, a printer, a facsimile machine, and a digital multi-functional system.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. An image forming apparatus, comprising:
an image bearing member to bear a toner image on a surface thereof;
an intermediate transfer member disposed facing the image bearing member, onto which the toner image is transferred;
a primary transfer device disposed opposite the image bearing member with the intermediate transfer member interposed therebetween, to transfer the toner image from the image bearing member onto the intermediate transfer member;
a secondary transfer device to transfer the toner image on the intermediate transfer member onto a recording medium;
a cleaning device detachably attachable relative to the intermediate transfer member, the cleaning device including a cleaning member to contact the surface of the intermediate transfer member to remove residual toner remaining on the intermediate transfer member after transfer; and
a lubricant application device detachably attachable relative to the intermediate transfer device, to apply a lubricant on the surface of the intermediate transfer member,
the cleaning device and the lubricant application device being detachably attachable independent of each other.

2. The image forming apparatus according to claim 1, further comprising:
a plurality of rollers disposed inside a loop formed by the intermediate transfer member,
wherein the intermediate transfer member is a belt formed into an endless loop entrained around and stretched taut between the plurality of rollers and rotated in a certain direction, and the cleaning device is disposed outside the looped intermediate transfer member and contacts one of the rollers via the intermediate transfer member.

3. The image forming apparatus according to claim 2, wherein the lubricant application device is disposed outside the loop formed by the intermediate transfer member and contacts one of the plurality of rollers disposed at the end of the loop via the intermediate transfer member.

4. The image forming apparatus according to claim 2, wherein the lubricant application device is disposed outside the loop formed by the intermediate transfer member and contacts one of the rollers, other than the one facing the cleaning device between the rollers at each end of the looped intermediate transfer member, via the intermediate transfer member.

5. The image forming apparatus according to claim 2, wherein the lubricant application device includes a brush roller driven by the roller other than the one facing the cleaning device when the roller rotates, and the brush roller is rotatable while contacting the surface of the intermediate transfer member.

6. The image forming apparatus according to claim 5, wherein the lubricant application device includes a solid lubricant and the brush roller scrapes the lubricant to apply the lubricant to the intermediate transfer member.

7. The image forming apparatus according to claim 1, wherein the cleaning device includes a toner transport member that transports the toner removed by the cleaning member from the intermediate transfer member to a certain place.

8. The image forming apparatus according to claim 7, wherein the toner transport member is driven by one of the rollers around which the intermediate transfer member is entrained.

9. The image forming apparatus according to claim 7, wherein the toner transport member is an auger screw made of resin.

10. The image forming apparatus according to claim 7, wherein the toner transport member is a helical member made of metal.

11. The image forming apparatus according to claim 1, wherein the cleaning member is a blade, a tip of which faces against the direction of travel of the intermediate transfer member and contacts the intermediate transfer member with a predetermined angle.

12. The image forming apparatus according to claim 1, wherein the cleaning device and the lubricant application device are detachably attachable independent of each other to a frame of the intermediate transfer member using a screw.
